(19) United States
(12) Patent Application Publication
(10) Pub. No.: US 2022/0332867 A1
(43) Pub. Date: Oct. 20, 2022

(54) HYDROXYALKYLAMIDE FUNCTIONALIZED ACRYLIC POLYMERS AND PROCESS FOR MANUFACTURING THEM

(71) Applicant: POLIRESIN S.R.L., Pozzolo Formigaro (AL) (IT)

(72) Inventor: Stefano MALACRIDA, Sovico (MB) (IT)

(21) Appl. No.: 17/639,384

(22) PCT Filed: Sep. 3, 2019
(86) PCT No.: PCT/IB2019/057419

§ 371 Date: Mar. 1, 2022

(51) Int. Cl. C08F 220/58

(52) U.S. Cl. CPC C08F 220/58

(57) ABSTRACT

The present invention refers to acrylic hydroxyalkyl amide functionalized polymers that can be useful as crosslinking agents or selfcrosslinking systems and to a process for manufacturing them.

### BACKGROUND OF THE INVENTION

The present invention refers to the field of acrylic polymers and of crosslinking agents to be used in the field of coating.

In particular, the present invention relates to the field of crosslinkers and selfcrosslinkable systems based on beta-hydroxyalkylamide functionalized acrylic polymers made by polymerizing beta-hydroxyl(meth)acrylammides or copolymerizing with ethylenically unsaturaded monomers (acrylates and methacrylates), styrene, substituted styrene, unsaturated anhydride, allyl alcohol, vinyl esthers et similar monomers, that can react via radical polymerization of the unsaturated carbon-carbon double bond.

Formaldehyde is a conventional reactant used for the preparation of the most common and efficient crosslinking agents like melamine, benzoguanamine and phenolic resins employed in the field of coating. However, formaldehyde is volatile and highly toxic, and for this reason, it is necessary its progressive removal from the processes for manufacturing chemicals. In the last years these types of crosslinkers have been manufactured with lower amount of free formaldehyde to be safer in handling but nevertheless during the thermal crosslinking there is always some decomposition and formation of free formaldehyde.

There are different systems that can be employed as an alternative to formaldehyde-based crosslinking agents: an example are free and blocked isocyanates but they are harmful products with a limited stability and cannot (free isocyanates) be used or can only be used with particular attention to evaporation rate (blocked isocyanates) with hydroxylated solvents. An interesting alternative is a class of molecules known as beta-hydroxylalkylamides, these structures are based on organic acid diamides, such as adipic or terephthalic amides, as disclosed, for example in U.S. Pat. No. 6,767,479B1 or EP1203763A2.

Beta-hydroxylalkylamides crosslinkers react with acidic functionalities starting from 140° C. and are largely used as crosslinking agents in powder coating and in some cases also in water based coating. These molecules are tetra-functionalized, i.e. comprise four beta-hydroxylalkylamides functions, such as the compounds having the following Formula IV:

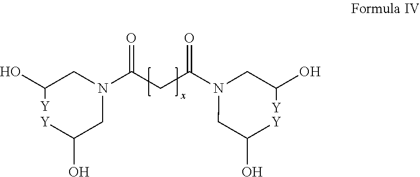

wherein Y is H or methyl, and x is comprised in the range of 2 to 6, being usually 4.

Conventional beta-hydroxylalkylamides have several drawbacks. Beta-hydroxylalkylamides are highly polar compounds and can be dissolved in aqueous solutions only. Accordingly, they have limited applications in many fields, such as in the paint field, wherein they can only be employed in powder coating and in water-based coating. Furthermore, the number of crosslinking groups per molecule, i.e. groups that provide crosslinks to crosslinkable polymers after curing, is limited.

Indeed, such groups are generally only four for the most used beta-hydroxylalkylamides in the industry, such as the ones of Formula IV shown above.

The drawbacks above greatly reduces the versatility and usefulness of beta-hydroxyalkylamides, which show inferior performances with respect to formaldehyde crosslinkers.

According to the above, there is the need of formaldehyde-free crosslinking agents that are more versatile than the ones currently used in the industry.

### SUMMARY OF THE INVENTION

Object of the present invention is to provide crosslinking agents that are not toxic, that are not derived from formaldehyde, that provide great performances and that can be formulated and employed in various media.

Further object of the present invention is to provide a process to manufacture such crosslinking agents.

These objects, along with other objects, are reached through the subject-matter of the present invention, namely an acrylic polymer containing hydroxyalkylamide crosslinkable side groups comprising, as polymerized units, one or more monomer selected from hydroxyalkylacrylamide monomer and hydroxyalkylmethacrylamide monomer (hydroxyalkyl(meth)acrylamide monomer for short).

It has been found that the polymer according to the present invention is a very effective crosslinking agent and is thus suitable for crosslinking and curing crosslinkable polymers.

The invention polymer overcomes the drawbacks of the conventional formaldehyde-free crosslinking agents, such as known beta-hydroxylalkylamides of formula IV above shown.

Indeed, the solubility of the invention polymer in various media can be modulated, for example by using appropriate co-monomers along with the monomers cited above during the polymerization process. Accordingly, the invention polymer can be soluble in aqueous media and/or in organic solvents, differently from the existing and conventional beta-hydroxylalkylamides of formula IV above shown, which are not soluble in organic solvents.

Moreover, the invention polymer bears an increased number of crosslinkable groups (i.e. hydroxyalkylamide functions) per molecule with respect to the number of crosslinking groups per molecule present in conventional formaldehyde-free crosslinking agents, which usually bear only four of such groups.

Furthermore, the invention polymer is very versatile, as its crosslinking density, flexibility, adhesion and compatibility with different polymeric systems can be modulated according to the requirements. This modulation can be done for example by polymerizing suitable co-monomers in suitable ratios with the hydroxyalkyl(meth)acrylamide monomers according to the invention.

Additionally, the invention polymer may be self-curing (i.e. self-crosslinking). The self-curing, or self-crosslinking invention polymer has been found having an increased stability and reactivity after curing compared to physical blends, i.e. blends of crosslinkable polymers and crosslinkers.

In preferred embodiments, the hydroxyalkyl(meth)acrylamide monomer has a formula according to Formula I:

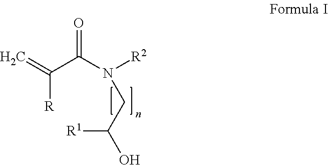

wherein: R is H or methyl,

R¹ is H or methyl,

R² is H or —(CH₂)ₘCH(R′)OH, with R′ being H or methyl, and m being 0 or 1, and n is 1 or more. Preferably, R² is —(CH₂)ₘCH(R′)OH and n is 1.

The invention polymer can be preferably prepared by polymerizing at least a further co-monomer along with the hydroxyalkyl(meth)acrylamide monomers. Preferably, the co-monomer is one or more selected from ethylenic unsaturated monomers as: acrylic and methacrylic monomers, styrene, substituted styrene, acrylonitrile and other unsaturated polymerizable molecules as maleic acid or anhydride, fumaric acid etc. in general ethylenic unsaturated anhydride, allyl alcohol, vinyl esters etc. The co-monomer may have a formula according to Formula II:

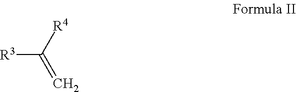

wherein R³ is phenyl, substituted phenyl, —COOH, or —COOR⁵, with R⁵ being a linear, branched, cyclic or aromatic C₁-C₈ alkyl group, preferably R³ is —COOH, or —COOR⁵, with R⁵ being a linear or branched C₁-C₈ alkyl group, and R⁴ is H or methyl.

In preferred embodiments, the invention polymer comprises at least a repeating unit derived from the polymerization of the monomer of Formula I, and optionally of the co-monomer of Formula II. Accordingly, the invention polymer can comprise repeating units having a formula according to formula III below, for example, when monomers of formula I and co-monomers of formula II are polymerized.

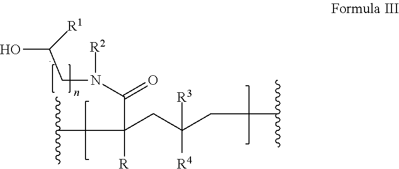

wherein R, R¹, R², R³, R⁴ and n are as defined above.

A further subject-matter of the invention is a process for manufacturing a hydroxyalkylamide polymer that comprises the step of subjecting to polymerization at least a monomer selected from hydroxyalkylacrylamide monomer and hydroxyalkylmethacrylamide monomer (hydroxyalkyl(meth)acrylamide for short). Free radical polymerization is preferred.

The hydroxyalkyl(meth)acrylamides can be obtained by reacting at least a hydroxyalkylamine with at least a (meth)acrylic compound (esther or chloride) or by reaction of (meth)acrylamide with ethylene oxide or propylene oxide, as described, for example, in U.S. Pat. No. 6,464,850B1.

The polymerization step of the invention process can be carried out with at least a further co-monomer, preferably with the further co-monomers as defined according to the present invention.

Another subject-matter of the invention is the use of the invention polymer in any of its embodiments as a crosslinking agent.

An additional subject-matter of the invention is a method for crosslinking polymers that comprises the steps of a) mixing the invention polymer as defined in the present invention with a crosslinkable polymer, thereby providing a mixture of invention polymer and crosslinkable polymer, and b) curing the curable mixture.

Subject-matter of the present invention is also a monomer mixture comprising at least a monomer selected from hydroxyalkylacrylamide monomer and hydroxyalkylmethacrylamide monomer (hydroxyalkyl(meth)acrylamide for short), and optionally at least a further co-monomer selected from acrylic monomers, methacrylic monomers, styrenic monomers and others ethylenic unsaturated monomers as above cited.

### DETAILED DESCRIPTION OF THE INVENTION

As stated above, the acrylic polymer bearing hydroxyalkylamide crosslinkable functionalities of the invention comprises, as polymerized units, one or more monomer selected from hydroxyalkylacrylamide monomer and hydroxyalkylmethacrylamide monomer. The invention polymer can thus be prepared by polymerizing the hydroxyalkyl(meth)acrylamide monomers mentioned above, and is suitable for crosslinking and curing crosslinkable polymers, as it bears hydroxyalkylamide functions that are able to generate cross-links in crosslinkable polymers containing carboxyl-functionality.

As used herein, “hydroxyalkylacrylamide monomer”, “hydroxyalkylmethacrylamide monomer” and the short “hydroxyalkyl(meth)acrylamide monomer” refer to acrylamide and/or methacrylamide compounds having one or preferably two hydroxyalkyl radical(s) bound to the (meth)acrylamidic nitrogen. Preferably, the hydroxyalkyl(meth)acrylamide monomer has a formula according to Formula I above.

As used herein, “crosslinking agent” and “crosslinker” refer to compounds/polymers that are able to bind to parts/groups of crosslinkable compounds/polymers when cured, thereby providing crosslinks in such crosslinkable compounds/polymers.

As used herein, “crosslinkable compound” and “crosslinkable polymer” refer to compounds and/or polymers that can be crosslinked when cured with a crosslinking agent. For example, the invention polymer is able to crosslink polymers comprising carboxylic acid groups and/or carboxylate groups.

As used herein, “curing”, “crosslinking” and other similar terms refer to the process of crosslinking a crosslinkable compound/polymer with a crosslinking agent.

As stated above, the monomer has preferably a formula according to Formula I:

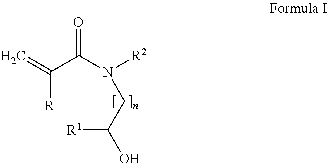

wherein: R, R¹, R² and n are as defined above.

More preferably, in Formula I above, n and m are 1, thereby providing a polymer having beta-hydroxyalkylamide groups. R² is preferably —(CH₂)ₘCH(R′)OH, so that the number of groups that are able to cure crosslinkable compounds (i.e. hydroxyalkylamide group) is increased.

Even more preferably, the monomer polymerized to obtain the invention polymer is one or more monomers selected from the Table I:

TABLE I

| Name | CAS | —R | —R¹ | —R² |
|---|---|---|---|---|
| N-Methyl-N-(2-hydroxyethyl)acrylamide | 17225-73-9 | —H | —CH₃ | —H |
| N,N-bis(2-hydroxyethyl)acrylamide | 10196-26-6 | —H | —CH₂CH₂OH | —H |
| N-Methyl-N-(2-hydroxy2-metylethyl)acrylamide | 1248069-14-8 | —H | —CH₃ | —CH₃ |
| N,N-bis(2-hydroxy2-metylethyl)acrylamide | 75310-21-3 | —H | —CH₂—CHCH₃OH | —CH₃ |
| N-Methyl-N-(2-hydroxyethyl)methacrylamide | 44889-30-7 | —CH₃ | —CH₃ | —H |
| N,N-bis(2-hydroxyethyl)methacrylamide | 45011-26-5 | —CH₃ | —CH₂CH₂OH | —H |
| N-Methyl-N-(2-hydroxy2-metylethyl)methacrylamide | 44889-30-7 | —CH₃ | —CH₃ | —CH₃ |
| N,N-bis(2-hydroxy2-metylethyl)methacrylamide | 955944-42-0 | —CH₃ | —CH₂—CHCH₃OH | —CH₃ |
| N-(2-hydroxyethyl)acrylamide | 7646-67-5 | —H | —H | —H |
| N-(2-hydroxyethyl)methacrylamide | 5238-56-2 | —CH₃ | —H | —H |
| N-(2-hydroxy2-metylethyl)methacrylamide | 21442-01-03 | —CH₃ | —H | —CH₃ |
| N-(2-hydroxy2-metylethyl)acrylamide | 99207-50-8 | —H | —H | —CH₃ |

The invention polymer deriving from polymerization of these monomers has been found particularly suitable to crosslink crosslinkable compounds. N,N-dihydroxyethylmetacrylamide (DHEMA-CAS #: 45011-26-5) and N,N-dihydroxypropylacrylamide (DHPAA-CAS #: 75310-21-3) are preferred.

As stated above, and as it can be observed in the experimental section, the polymer of the invention can be soluble in different media, e.g. aqueous solutions and/or organic, nonpolar solvents. Accordingly, the solubility of the invention polymer in different media can be modulated. This can be done, for example, by polymerizing at least a further co-monomer along with the hydroxyalkyl acrylamide monomer and/or hydroxyalkyl methacrylamide monomer. For example, the invention polymer can be dissolved in organic nonpolar media when hydroxyalkyl (meth)acrylamide monomers are polymerized with a suitable amount of hydrophobic co-monomer(s).

The invention polymer is thus versatile and useful in many applications, as it can be employed and formulated in various media.

As stated above, preferred co-monomers are selected from acrylic monomers, methacrylic monomers, styrene, substituted styrene acrylonitrile and other unsaturated polymerizable molecules as maleic acid or anhydride, fumaric acid and in general ethylenically insaturated anhydride, allyl alcohol, vinyl esthers etc., and can have the following Formula II:

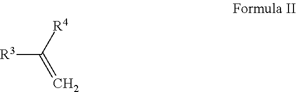

wherein R³ and R⁴ are as defined above. It has been found that the invention polymer that comprises as polymerized units these co-monomers and the hydroxyalkyl (meth)acrylamide monomers provides excellent crosslinking properties, such as solvent resistance, to crosslinkable compounds/polymers after curing. More preferably, the co-monomer is one or more selected from methacrylic acid, methylmetacrylate, butylacrylate, styrene and ethylhexylacrylate.

The invention polymer comprises at least a repeating unit derived from the polymerization of the hydroxyalkyl (meth)acrylamide monomers, preferably of Formula I, and optionally of the co-monomer, preferably of Formula II. Accordingly, the invention polymer can comprise the repeating units having a formula according to formula III below.

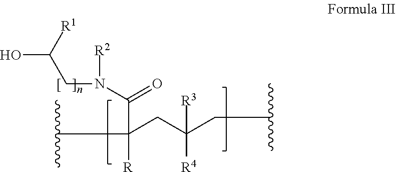

wherein R, R¹, R², R³, R⁴ and n are as defined above. Preferably, R² is —(CH₂)ₘCH(R′)OH, and n and m are 1.

The repeating unit of Formula III has been found very effective to provide crosslinks in crosslinkable compounds and polymers.

Another advantage related to the use of acrylic system is the strong stability to hydrolysis of the polymeric chain with respect to polyesters, for example, that are more sensitive.

According to certain embodiments, crosslinks within the invention polymer can be generated simply by curing it, without the addition of other crosslinkable polymers; in other words, a curing process carried out on the invention polymer alone (without other polymer(s)) provides a crosslinked polymer. Accordingly, in certain embodiments, the invention polymer can also be a self-crosslinking polymer. As it can be observed in the experimental section, the self-crosslinking invention polymer, after curing, has been found particularly resistant to solvents and to chemically aggressive conditions such as, for example, sterilization on autoclave at 130° C. for 1 hour in a solution of 5% lactic acid in water.

The self-crosslinking invention polymer can be obtained for example by polymerizing hydroxyalkyl (meth)acrylamide monomers with one or more (meth)acrylic co-monomers, e.g. the co-monomers of formula II above with R³=—COOH, or —COOR⁵. Such a polymerization would provide an invention polymer comprising repeating unit of formula III above, with R³=—COOH, or —COOR⁵.

The self-crosslinking invention polymers can also be cured using a broad ranges of curing temperatures, for example at 130° C. for long curing time (e.g. 30 minutes) and at 200° C. for shorter curing time (e.g. 3 minutes).

As stated above, a further subject-matter of the invention is a process for manufacturing a hydroxyalkylamide polymer, e.g. the invention polymer as herein disclosed, that comprises the step of subjecting to polymerization at least a hydroxyalkyl (meth)acrylamide monomer. Preferably, such hydroxyalkyl (meth)acrylamide monomers are as defined according to the present invention.

The polymerization is preferably a free radical polymerization, and can be carried out in solution or in an emulsion. Conventional radical initiators can be used, such as azobisisobutyronitrile (AIBN) and 2,2′-azobis 2-methylbutyronitrile. Traces of monomers after the polymerization reaction is concluded can be eliminated by adding a further amount of radical initiator (boost).

It can be advantageous, in case of self-crosslinking systems, to carry out the polymerization step at temperatures below 120° C., preferably at 90 to 105° C., as otherwise crosslinking and gelation might occur. This might happen in particular when carboxylic acids co-monomers (such as (meth)acrylic acids) are used in the polymerization step.

Advantageously, the invention process comprises a further step upstream of the polymerization step, such further step comprising reacting at least a hydroxyalkylamine with at least a (meth)acrylic compound, whereby the hydroxylalkyl (meth)acrylamide monomers to be subsequently polymerized are obtained. Preferably, such further step is carried out in the presence of a base.

As used herein, (meth)acrylic compound refers to a compound selected from acrylic acids, acrylic esters, acrylic salts, methacrylic acids, methacrylic esters, and methacrylic salts. Preferably, the (meth)acrylic compound is a (meth)acrylic ester, and more preferably is selected from methyl methacrylate, ethyl methacrylate, butyl methacrylate, ethylhexyl methacrylate, methyl acrylate, ethyl acrylate and butyl acrylate.

The hydroxyalkylamine to be reacted with the (meth)acrylic compound to provide the hydroxyalkyl (meth)acrylamide monomer can be advantageously selected from a list of primary or secondary betahydroxylamines. Depending on the application desired, the degree of branching can be set via the alkanolamines chosen. Example of suitable alkanolamines include: a) mono-β-alkanolamines:ethanolamine, N methyl ethanolamine (MEA), n-ethyl ethanolamine, N-butyl ethanolamine, N-methyl isopropanolamine, isopropanoalamine n-propanolamine, isobutanolamine, β-cyclohexanolamine, N-butyl isopropanolamine and; b) di β-alkanolamines Bis(hydroxyethyl)amine (DEA) 3-amino-1,2-propanediol, 2-amino-1,3-propanediol, diisobutanolamine (bis-2-hydroxy-1-butyl)amine, di-β-cyclohexanolamine and diisopropanolamine (DIPA) (bis-2-hydroxy-1-propyl)amine. c) a suitable trialkanolamine is tri 2-Amino-2-(hydroxymethyl)-1,3-propanediol, Tris(hydroxymethyl)aminomethane. More preferable advantageously is Bis(hydroxyethyl)amine (DEA), monoethanolamine (MEA) and diisopropanolamine (DIPA).

It has been found that the yields of the reactions of the (meth)acrylic compound, in particular of (meth)acrylic esters, with the hydroxyalkylamine improve the smaller the leaving group of the (meth)acrylic esters is. Accordingly, as it can be observed in the experimental section, the yields improve by using methyl>ethyl>buthyl>ethylhexyl (meth)acrilates.

As stated above, the invention polymer can be obtained by polymerizing a further co-monomer along with the hydroxyalkyl (meth)acrylamide monomer. Accordingly, the polymerization step of the invention process can be carried out with at least a further co-monomer together with the (meth)acrylamide monomer. Preferably, such further co-monomer is one or more co-monomers as defined above, e.g. acrylic monomers, methacrylic monomers and styrenic monomers.

According to certain embodiments, the invention process can thus comprise a first step of reacting a hydroxyalkylamine with at least a (meth)acrylic compound to obtain a hydroxylalkyl (meth)acrylamide monomer (e.g. as shown in Scheme 1 below), and a second step of polymerizing the obtained hydroxylalkyl (meth)acrylamide monomer, optionally along with a further co-monomer, to obtain the invention polymer (e.g. as shown in scheme 2 below).

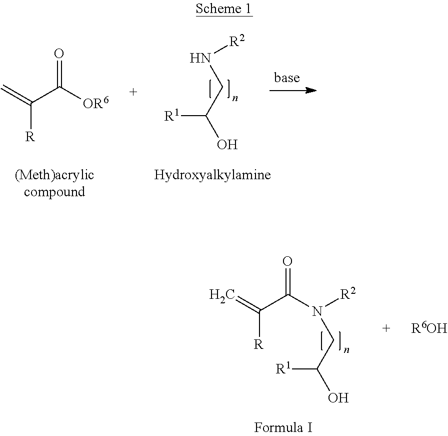

wherein R, R¹, R², and n are as above defined, and

R⁶ is H, a linear, branched, cyclic or aromatic C1-C8 alkyl group, or a negative charge.

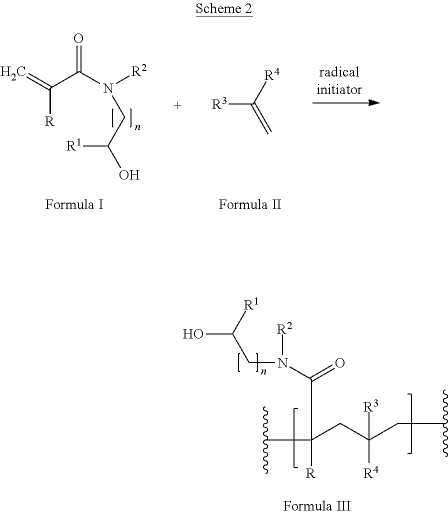

wherein R, R¹, R², R³, R⁴, R⁵ and n are as above defined.

Advantageously, the invention process does not necessarily require purification from unreacted (meth)acrylic compounds after their reaction with hydroxyalkylamine, as eventual unreacted (meth)acrylic compounds can be polymerized as co-monomers in the subsequent polymerization reaction.

Alcohol by-products of the reaction of (meth)acrylic compounds with hydroxyalkylamine (e.g. R⁶OH in Scheme 1 above) are volatile and can be easily eliminated for example by evaporation, e.g. by creating a vacuum and slightly heating at 80 to 85° C. Advantageously, higher alcohol such as n-butanol can be kept as solvent for the subsequent polymerization reaction.

Preferably, in the polymerization step, when co-monomers are polymerized with the hydroxyalkyl (meth)acrylamide monomers, the weight ratio of (meth)acrylamide monomers/co-monomers is comprised in the range of 100:1 to 0.01:10, more preferably of 50:1 to 0.05:1, even more preferably of 30:1 to 0.1:1, and most preferably of 15:1 to 0.25:1. Accordingly, depending on the amount and type of co-monomer(s) used in the polymerization steps, invention polymers having different characteristics (e.g. solubility, flexibility, adhesion, etc.) can be manufactured.

Another subject-matter of the invention is the use of the invention polymer in any of its embodiments as a crosslinking agent. As it is demonstrated by the examples in the experimental section, the invention polymer is an effective crosslinker. Indeed, after curing, the invention polymer provides exceptional solvent resistance properties to crosslinkable polymer (or to itself, when it is self-crosslinking), both in aqueous solutions and in organic solvents.

The polymer, according to the invention, can be advantageously used for the formulation of polymeric coatings, particularly wherein said coatings are obtained by thermal treatment. In addition to the above, said polymeric coatings can be advantageously applied on metals.

Accordingly, an additional subject-matter of the invention is a method for crosslinking crosslinkable polymers that comprises the steps of a) mixing the invention polymer as defined in the present invention with a crosslinkable polymer, thereby providing a mixture of invention polymer and crosslinkable polymer, and b) curing the curable mixture.

The step b) of curing can be carried out as known in the art, and preferably by heating the invention polymer and crosslinkable polymer mixture prepared in step a), for example at a temperature higher than 120° C. The curing temperature can depend on the curing time, i.e. the time in which step b) is carried out.

The amount of invention polymer and of crosslinkable polymer can be selected, for example based on the acid number (or acid value) of the crosslinkable polymer. The acid value is the amount in milligrams of KOH that is required to neutralize one gram of crosslinkable polymer, and is related to the amount of acid groups (e.g. carboxylic acid group) present in the polymer. For example, for a crosslinkable polymer having an acid value comprised in the range of 50 to 175, preferably of 75 to 125, the weight ratio of crosslinkable polymer/invention polymer can be 80:20 to 50:50, preferably 70:30 to 60:40.

When the invention polymer is self-crosslinking, then a method for crosslinking according to the present invention can comprise the step of simply curing the invention polymer, for example as in step b) mentioned above, without mixing any crosslinkable polymer to the invention polymer (.e. without carrying out step a) mentioned above).

Subject-matter of the present invention is also a monomer mixture comprising at least a monomer selected from hydroxyalkylacrylamide monomer and hydroxyalkylmethacrylamide monomer as herein disclosed, and optionally at least a further co-monomer selected from acrylic monomers, methacrylic monomers and styrenic monomers as herein disclosed. Such a monomer mixture can be polymerized for example according to the process of polymerization disclosed above and it is useful to provide the invention polymer. The amount of hydroxyalkyl(meth)acrylamide monomer and of co-monomers in the invention mixture can preferably be comprised within the ranges of weight ratio disclosed above.

### EXPERIMENTAL SECTION

The invention is herein disclosed in more details by means of the following examples, which are meant for illustrative purposes only and are not meant to limit the scope of the invention.

### Example 1—Preparation of Six Hydroxylalkyl (Meth)Acrylamide Monomers by Reacting (Meth)Acrylic Compounds with Hydroxyalkylamines

Six hydroxylalkyl (meth)acrylamide monomers have been prepared and are summarized in Table 2 below. To prepare such monomers, (meth)acrylic compounds, in particular esters (“Ester” in Table 2 below), are reacted with hydroxyalkylamines (“Amine” in Table 2 below) in the presence of a Base (see scheme 1 above). The conversion of the reagents into the product has been determined by FT-IR spectroscopy.

In Table 2, “Alcohol” refers to the alcohol by-product formed in the reaction (see R⁶OH in Scheme 1 above).

TABLE 2

| Ester | Amine | Base | Monomer | Yield | Alcohol |
|---|---|---|---|---|---|
| MMA | DEA | NaOCH₃ | DHEMA | ~95% | Methanol |
| MMA | MEA | NaOCH₃ | HEMA | ~95% | Methanol |
| MMA | DIPA | NaOCH₃ | DHPMA | ~95% | Methanol |
| MMA | DEA | NaNH₂ | DHEMA | ~95% | Methanol |
| MMA | DEA | tBuOK | DHEMA | ~95% | Methanol |
| EMA | DEA | NaOCH₃ | DHEMA | ~75% | Ethanol |
| BMA | DEA | NaOCH₃ | DHEMA | ~55% | Buthanol |
| EHMA | DEA | NaOCH₃ | DHEMA | ~30% | EthylHexanol |
| MA | DEA | NaOCH₃ | DHEAA | ~95% | Methanol |
| MA | MEA | NaOCH₃ | HEAA | ~95% | Methanol |
| MA | DIPA | NaOCH₃ | DHPAA | ~95% | Methanol |
| MA | DEA | NaNH₂ | DHEAA | ~95% | Methanol |
| EA | DEA | NaOCH₃ | DHEAA | ~75% | Ethanol |
| BA | DEA | NaOCH₃ | DHEAA | ~55% | Buthanol |

wherein MMA is methyl methacrylate, EMA is ethyl methacrylate, BMA is butyl methacrylate, ERMA is ethylhexyl methacrylate, MA is methyl acrylate, EA is ethyl acrylate, BA is butyl acrylate, DEA is diethanolamine, MEA is monoethanol amine, DIPA is diisopropanol amine, DHEMA is N,N-dihydroxyethylmethacrylamide, HEMA is N-hydroxyethylmethacrylamide, DHPMA is N,N-dihydroxypropylmethacrylamide, DHEAA is N,N-dihydroxyethylacrylamide. HEAA is N-hydroxyethylacrylamide, and DHPAA is N,N-dihydroxypropylacrylamide.

As it can be observed by Table 2, the best yields have been obtained with the smallest leaving groups: Methyl>Ethyl>Buthyl>Ethylhexyl.

There is not a significant correlation between reactivity and steric hindrance of the amines. The difference between the bases tested is not significant

### Example 2—Preparation and Test of Invention Polymers

### Example 2.1—Preparation of a Self-Curing Invention Polymer and Solvent Resistance Test

A mixture of diethanolamine (DEA), 320 g, and Sodium Methoxide (CH₃ONa), 0.5 g, is placed in a 2000-ml glass reactor and blanketed with nitrogen. This mixture is heated to 50° C. At this point Methylmethacrylate (MMA) is introduced into the mixture dropwise; MMA (300 g) is added over 2 hours during which methanol is simultaneously distilled from the reaction mixture by applying vacuum. The reaction conversion is observed by FT-IR.

The product obtained N,N-dihydroxyethylmethacrylamide (DHEMA CAS:45011-26-5 220 g-monomer) is mixed with Methacrylic Acid (50 g) and Methylmetacrylate (230 g) (co-monomers). A mixture of Vazo 67® (2,2′-Azobis 2-methylbutyronitrile 20 g) and butoxyethanol (50 g) is prepared and the two mixtures are simultaneously dropped in 2 hours at 100° C. in butoxyethanol (150 g). After the dropping finishes, two boosts of 1 g each of Vazo 67® are added to reach complete conversion. The reaction is cooled at 80° C., the polymer is neutralized with Dimethylethanolamine (DMEA 70 g) and diluted with warm water (300 g).

The product is applied with a 12 μm barcoater on two different tinplate sheets and cured at different conditions:

1-5 minutes at 200° C.,

2-30 minutes at 140° C.

Both the applications resulted to be solvent resistant, as the crosslinked film produced after curing tolerated more than 100 methyl ethyl ketone (MEK) double rubs according to standard ASTM D4752

### Example 2.2—Preparation of a Self-Curing Invention Polymer and Solvent Resistance Test

N,N-dihydroxyethylmethacrylamide (DHEMA CAS:45011-26-5 240 g) produced as in Example 2.1 is mixed with Butylacrilate (240 g), Styrene (300 g) and Methacrylic Acid (140 g). A mixture of Vazo 67® (2,2′-Azobis 2-methylbutyronitrile 20 g) and butoxyethanol (50 g) is prepared and the two mixtures are simultaneously dropped in 3 hours at 95° C. in butoxyethanol (350 g). The reaction is cooled at 80° C., the polymer is neutralized with Diisopranolamine (DIPA 100 g) and diluted with warm water (350 g). The product is diluted in water to 20%±1% solid and pH corrected with DIPA to reach pH 8.0.

The product is applied on a metal panel with a barcoater and cured at 140° C. for 30 minutes. The so-produced crosslinked film showed more than 100 MEK double rubs according to standard ASTM 4752and therefore it is considered solvent resistant.

### Example 2.3—Preparation of a Invention Omopolymer and Solvent Resistance Test

N,N-dihydroxypropylacrylamide (DHPAA CAS:75310-21-3) is produced from Methylacrylate 340 g and Diisopranolamine 450 g catalysed by Sodium methoxide 1,5 g following the method described in Example 2.1.

450 g of product obtained was dropped in a 3 Kg reactor, under nitrogen, charged with 400 g of butyl glycol (350 g) with 5 grams of Vazo 67. Reaction was conducted at 105° C. by dropping monomer and diazo initiator over 2 hours.

The product obtained was mixed with an acrylic resin (crosslinkable polymer) with acid number of 75 on a ratio of 60 (resin):40 (crosslinker) solid on solid, applied on tinplate with a 6 μn barcoater and cured for 5 minutes at 180° C. The so-produced crosslinked film tolerated more than 100 MEK double rubs according to standard ASTM D5752, and therefore is considered solvent resistant.

### Example 2.4—Preparation of a Water-Soluble Invention Polymer

N,N-dihydroxyethylmethacrylamide (DHEMA) CAS:45011-26-5 is produced as described in Example 2.1.

1200 g of DHEMA are charged in a 4 liters reactor and diluted with Butyl glycol 800 g, 100 g of Methacrylic acid are added slowly under stirring, a low increase in temperature (exothermic reaction) is generated by the unreacted ammine. The mixture is heated under nitrogen flux to 100° C. and a solution of 15 grams of Vazo 67® in 200 g of butyl glycol are dropped inside the reaction mixture in 2 hours and 30 minutes.

The obtained product was neutralized 75% on moles with DMEA and dissolved in warm water (60° C.).

### Example 2.5—Preparation of a Solvent Based Invention Polymer

N,N-dihydroxyethylmethacrylamide (DHEMA CAS:45011-26-5 240 g) is produced as described in Example 2.1.

800 g of the obtained product are charged in a 4 liters reactor and diluted with Butyl glycol 800 g. 200 g of 2-ethylhexylacrylate and 10 g of Methacrylic acid are added under stirring. The mixture is heated under nitrogen flux to 100° C. and a solution of 15 grams of Vazo 67® in 200 g of butyl glycol is dropped inside the reaction mixture in 2 hours and 30 minutes.

### Example 3—Comparative Tests

For comparative tests, a commercial acrylic resin with an acid value of 100 (A.N. 100) was used. In particular, such acrylic resin was prepared using Example 2.2 formulation but substituting DHEMA with Hydroxypropylmetacrylate (HPMA).

The acrylic resin was crosslinked with different crosslinkers, namely with the invention polymers of 2.4 and 2.5 or with conventional crosslinkers (comparative), according to the following procedure.

A crosslinking mixture of commercial acrylic resin+invention polymer or conventional crosslinker was prepared by mixing a weight ratio of acrylic resin/crosslinker of 70:30. The, the mixture was diluted to 40% solid with water or solvent (Methoxy propyl acetate (PMA)/Butanol—50:50). Finally, the diluted mixture was applied on tinplate with 12 micron barcoater and cured at 200° C. for 5 minutes.

Table 2 reports the results of MEK double rubs according to standard ASTM D4752 and of the appearance of the crosslinked film, for the crosslinked acrylic resin films produced according to the above procedure, as well as of a self-crosslinking invention polymer crosslinked film.

TABLE 3

| | | | PMA/Butanol | | | |
|---|---|---|---|---|---|---|
| | | | 1:1 | | Water | |
| Crosslinkable | | Compos. | ASTM | | ASTM | |
| polymer | Crosslinker | (w/w) | D4752 | Film | D4752 | Film |
| Acrylic A.N | PRIMID ® | 70/30 | / | Not | 60 | Bright |
| 100 | QM 1260 | | | comp. | | |
| | (comparative) | | | | | |
| Acrylic A.N | PROSID ® | 70/30 | / | Not | 70 | Hazy |
| 100 | 411 | | | comp. | | |
| | (comparative) | | | | | |
| Acrylic A.N | Example 2.4 | 70/30 | 40 | Low | 90 | Bright |
| 100 | | | | comp. | | |
| Acrylic A.N | Example 2.5 | 70/30 | 90 | Bright | 60 | Bright |
| 100 | | | | | | |

| | | | | | |
|---|---|---|---|---|---|
| Example 2.2 (self- | 100 | >100 | Bright | >100 | Bright |
| crosslinking) | | | | | |

The conventional crosslinker used, namely PRIMID® QM 1260 and PROSID® 411 (as currently available on the market), are conventional beta-hydroxylalkylamides supposed to have a chemical structure as described in Formula IV above.

It is possible to observe from Table 3 that the invention polymers, i.e. the crosslinkers of Examples 2.2, 2.4, and 2.5, can be effectively used as crosslinkers and during curing in both water and organic solvents (i.e. PMA/Butanol 1:1).

Moreover, according to the results provided in Table 3, the solvent resistance that the invention polymers provide after curing is comparable to, the solvent resistance provided by conventional formaldehyde-free crosslinkers.

Finally, the self-crosslinking intention polymer of Example 2.2 has been found having an increased stability, reactivity and solubility both in water and in organic solvents compared to physical blends.

1. An acryilic polymer comprising, as polymerized units, one or more monomers selected from hydroxyalkylacrylamide monomer and hydroxyalkylmethacrylamide monomer.

2. The polymer according to claim 1, wherein said monomers have the following Formula I: 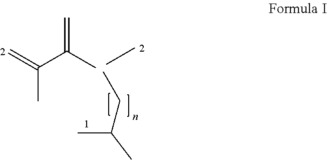
wherein: R is H or methyl,
R¹ is H or methyl,
R² is H or —(CH₂)ₘCH(R′)OH, with R′ being H or methyl, and m being 0 or 1, and
n is 1 or more,

3. The hydroxyalkylamide polymer according to claim 2, wherein said monomer is selected from:
N-Methyl-N-(2-hydroxyethyl)acrylamide (CAS 17225-73-9);
N,N-bis(2-hydroxyethyl)acrylamide (CAS 10196-26-6);
N-Methyl-N-(2-hydroxy2-metylethyl)acrylamide (CAS 1248069-14-8);
N,N-bis(2-hydroxy2-metylethyl)acrylamide (CAS 75310-21-3);
N-Methyl-N-(2-hydroxyethyl)methacrylamide (CAS 44889-30-7);
N,N-bis(2-hydroxyethyl)methacrylamide (CAS 45011-26-5);
N-Methyl-N-(2-hydroxy2-metylethyl)methacrylamide (CAS 44889-30-7);
N,N-bis(2-hydroxy2-metylethyl)methacrylamide (CAS 955944-42-0);
N-(2-hydroxyethyl)acrylamide (CAS 7646-67-5);
N-(2-hydroxyethyl)methacrylamide (CAS 5238-56-2);
N-(2-hydroxy2-metylethyl)methacrylamide (CAS 21442-01-03); and
N-(2-hydroxy2-metylethyl)acrylamide (CAS 99207-50-8).

4. The hydroxyalkylamide polymer according to claim 1, wherein said polymer further comprises, as polymerized units, at least a co-monomer selected from ethylenically unsaturaded monomers (acrylates and methacrylates), styrene, substituted styrene, unsaturated anhydride, allyl alcohol, vinyl esthers or monomers that can react via radical polymerization of the unsaturated carbon-carbon double bond.

5. The hydroxyalkylamide polymer according to claim 4, wherein said further co-monomer has the following Formula II: 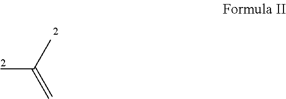
wherein R³ is phenyl, substituted phenyl, —COOH, or —COOR⁵, with R⁵ being a linear, branched, cyclic or aromatic C₁-C₈ alkyl group, and
R⁴ is H or methyl.

6. The hydroxyalkylamide polymer according to claim 5, wherein said further co-monomer is selected from methacrylic acid, methylmetacrylate, butylacrylate, styrene and ethylhexylacrylate.

7. The hydroxyalkylamide polymer according to claim 1, comprising the repeating units of formula III: 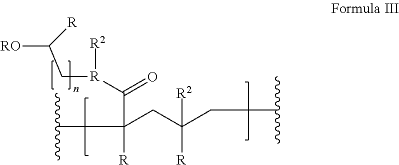
wherein R, R¹, R², R³, R⁴ and n are defined as in claims 2 and 5.

8. A process for manufacturing a hydroxyalkylamide polymer comprising the step of subjecting to polymerization at least a monomer selected from hydroxyalkylacrylamide monomer and hydroxyalkylmethacrylamide monomer.

9. The process according to claim 8, wherein said monomer is selected from hydroxyalkylacrylamide monomer and hydroxyalkylmethacrylamide monomer.

10. The process according to claim 8, wherein said monomer is obtained by reacting at least a hydroxyalkylamine with at least a (meth)acrylic compound.

11. The process according to claim 10, wherein said hydroxyalkylamine is selected from diethanolamine (DEA), monoethanolamine (MEA) and diisopropanolamine

12. The process according to claim 10, wherein said (meth)acrylic compound is selected from acrylic acids, acrylic esters, acrylic salts, methacrylic acids, methacrylic esters, and methacrylic salts.

13. The process according to claim 8, wherein said polymerization step is carried out with at least a further co-monomer selected from ethylenically unsaturaded monomers (acrylates and methacrylates), styrene, substituted styrene, unsaturated anhydride, allyl alcohol, vinyl esthers or monomers that can react via radical polymerization of the unsaturated carbon-carbon double bond.

14. Method of crosslinking and curing crosslinkable compounds with the polymer as defined in claim 1, said method comprising
a. mixing said polymer with said crosslinkable compound, thereby obtaining a mixture of said polymer and said crosslinkable compound; and
b. curing said curable mixture.

15. The method according to claim 14, to obtain polymeric coatings.

16. The method according to claim 15, wherein said coatings are obtained by thermal treatment.

17. The method according to claim 15, wherein said polymeric coatings are applied on metals.

18. The method according to claim 14, wherein said poymer is the hydroxyalkylamide polymer as defined in claim 1.

19. A monomer mixture comprising at least a monomer selected from hydroxyalkylacrylamide monomer and hydroxyalkylmethacrylamide monomer as defined in claim 1, and optionally at least a further co-monomer as defined in claim 4.
